(19) United States
(12) Patent Application Publication
(10) Pub. No.: US 2019/0347661 A1
(43) Pub. Date: Nov. 14, 2019

(54) COORDINATOR MANAGED PAYMENTS

(71) Applicant: SECURTER SYSTEMS INC., Bradford (CA)

(72) Inventors: Andrei GRENADER, Hadera (IL); Yefim LEIFMAN, Or-Akiva (IL)

(73) Assignee: SECURTER SYSTEMS INC., Bradford, ON (CA)

(21) Appl. No.: 16/462,548

(22) PCT Filed: Nov. 7, 2016
(86) PCT No.: PCT/CA2016/051294

§ 371 Date: May 21, 2019

Related U.S. Application Data
(60) Provisional application No. 62/257,250, filed on Nov. 19, 2015.

(51) Int. Cl. G06Q 20/40; G06Q 20/34

(52) U.S. Cl. CPC G06Q 20/401; G06Q 2220/00; G06Q 20/341

(57) ABSTRACT

An apparatus for managing smart card transactions includes one or more communication interfaces for connecting to processors of vendors, customers and payment server processors and a processor configured to receive details of a transaction from a vendor processor, to transmit the transaction details to a smart card reader identified by the received details, to receive from a smart card within the smart card reader a cryptogram authorizing the transaction, to transfer the details of the transaction and the cryptogram to a payment server processor (PSP) to carry out the transaction, to receive confirmation of the transaction from the PSP through the interface and to transmit confirmation of the transaction to both the vendor processor and a customer processor.

### FIELD OF THE INVENTION

The present invention relates to smart card transaction management and particularly to management of transactions by a trusted coordinator. The coordinator allows, inter alia, to separate the security of one participating party from the security of others while, in the case of payment transactions, keeping compatibility with the EMV specification. The proposed management method is suitable for transactions when a cardholder wishes to perform a transaction from almost any location independently of the security of communication means in that location.

### BACKGROUND

Smart cards are used to perform secure transactions, in particular, monetary or payment transactions. The payment transactions are carried out by several parties, including a consumer, which is in the same time a cardholder, a merchant, a merchant's acquirer, a credit card company and a settlement bank designated by the credit card company, and a card issuer. In the EMV specification, acquirers and issuers are called payment service providers (PSP). However, in practice, often a separate organization performing some of the functions on behalf of an acquirer is also called PSP. These parties bear their share of responsibility for the transaction. The payment transaction process is illustrated by FIG. 2.2 of Gerts E., Towards an Improved EMV Credit Card Certification, Master Thesis, TUDelft, 2007, available from http://swerl.tudelft.nl/twiki/pub/Main/EtienneGerts/Thesis_ECAGerts.pdf. The EMV transaction flow is illustrated by FIG. 4-1: Sample transaction flow diagram from Transaction Acceptance Device Guide, Version 2.2, July 2014 by Visa available from https://technologypartner.visa.com/Library/Specifications.aspx. The smart card is employed to reduce the chances that an invalid transaction will be authorized. Detailed information on smart cards can be obtained from ISO/IEC 7816. A smart card reader is used to communicate with the smart card.

In the context of mobile point of sale (mPOS), the smart card reader is usually supplied by the PSP to a merchant (referred to herein also as a “vendor”), who uses it to connect to the smart cards of consumers. This can involve a security breach, for example, if the merchant's part of the system is compromised.

US patent publication 2015/0186866 to Lund describes a method of conducting mobile point of sale smart card payments using a portable smart card reader connected to a mobile phone or a computer of a merchant and through it to a server with EMV terminal logic. The smart card reader encrypts sensitive smart card information in communicating with the EMV terminal logic. For a cardholder, use of this method is limited to the location of the merchant. Here encryption is performed with a unique key per smart card reader.

U.S. Pat. No. 5,336,870 to Hughes and Molina describes a terminal and system for home or office initiated purchase payment transactions, bill payment transactions and other electronic transactions using a magnetic card reader. Here encryption is performed with a derived unique key per transaction (DUKPT) algorithm.

In some cases, transactions are initiated remotely by a cardholder over the Internet.

U.S. Pat. No. 6,282,522 to Davis et al. describes use of a smart card for remotely initiated online purchases. However, this patent does not propose any means to prevent unauthorized use of the smart card if a cardholder's part of the system is compromised.

The following two patents consider methods of card reader connection.

U.S. Pat. No. 8,972,584 to Sojian describes a cardholder's processing unit which is “configured as an application server and is further configured to: (a) receive, from a remote computing device, a web service interface to a communication layer of a smart card reader that is available; and (b) establish a resource in the system device list to make the smart card reader available as a local resource to Personal Computer/Smart Card (PCSC) applications.”

U.S. Pat. No. 6,247,644 to Home et al. describes a smart card drive which can connect to any peer node in a local area network.

US patent publication 2010/0082492 to Jarman et al. describes an electronic payment system including a vendor smart card reader and a purchaser smart card reader, connected to a vendor terminal. The system allows transfer of payment between a purchaser smart card and a vendor smart card.

WYSIWYS (What You See Is What You Sign) devices are also used for smart card transactions. PCT publication WO2014/106181 to Breams describes a secure signing device that “may further comprise a communication interface to connect the secure signing device to a general purpose computing device and to receive data to be presented to the user for review and approval and to be signed by the users private key.” This key can be contained on a smart card or secure access module (SAM). This method is not compatible with the EMV specification.

### BRIEF DESCRIPTION OF THE DRAWINGS

The present invention will be more fully understood from the following detailed description of the embodiments thereof, taken together with the drawings in which:

FIG. 1 is a block diagram of entities and units participating in a remote smart card transaction performed using a coordinator, in accordance with an embodiment of the present invention; and

FIG. 2 is a schematic illustration of the communications involved in a monetary transaction, in accordance with an exemplary embodiment of the invention.

### DETAILED DESCRIPTION OF EMBODIMENTS

An aspect of some embodiments of the present invention relates to a trusted coordinator for coordinating smart card based transactions, such as payment transactions. The coordinator receives transaction details and/or confirmations of transaction details to be authorized and performed, from both sides of the transaction, and transfers the received information together to a separate transaction service provider (TSP), for example, a payment service provider (PSP), which carries out the transaction. We shall call the side of the transaction, other than the cardholder, the recipient or the vendor. Receiving the transaction details or their confirmations from both sides of the transaction by the trusted coordinator allows a recipient to enter his part of transaction details directly to the coordinator and thereby this allows the cardholder to use his/her own smart card reader without the cardholder's reader having to receive the transaction details directly from the recipient of a transaction. In some embodiments, which will be described further, the coordinator provides cardholders and recipients a means to check transaction details before authorization. This ensures the safety and non-repudiation of the transaction, as both sides of the transaction provided consent separately. Particularly, the coordinator provides a web Application Programming Interface API (application program interface) to recipients.

One embodiment of the invention is the payment system for remotely initiated payments, which has What You See Is What You Sign capabilities, and which is compatible with EMV. That is the coordinator takes care to provide What You See Is What You Sign capabilities and EMV compatibility for remotely initiated payments.

In some embodiments, the coordinator hosts smart card terminal logic, for example, EMV Level 2 kernel software, or a part of the terminal logic. In the case when the coordinator hosts EMV Level 2 kernel, the coordinator can participate in offline card data authentication or offline cardholder authentication. In the case of online card data and cardholder authentications, the coordinator does not participate in authentication of the smart card and the cardholder. The coordinator may not participate in operations regarding the transfer of the funds, such as clearing and settlement. When a PSP acts on behalf of an acquirer, the coordinator optionally may not directly contact banks. In other embodiments, for example when the acquirer operates as a PSP, the coordinator is in direct contact with the bank.

In these embodiments, the coordinator receives plaintext, encrypted, or signed data from the smart card through a smart card reader, cardholder's computer (general purpose computing device) and the Internet and transfers this data to the PSP, optionally with other transaction details. According to the EMV specification, the coordinator can not access secret information required to authenticate or decrypt EMV data transmissions to or from the PSP. Particularly, in these embodiments, the coordinator does not store the PINs of smart cards and does not have access to the PINs. In addition, in these embodiments, the coordinator does not store and does not have access to cryptographic keys used in communicating between the smart cards and the card issuer.

Optionally, the coordinator may operate with a plurality of different TSPs. In some embodiments of the invention, the coordinator determines the TSP to which the details of a specific transaction are to be transmitted, from details of the transaction or the smart card and/or the smart card reader, such as a specific TSP with which the smart card or smart card reader or transaction are associated. It is noted that details of transactions originated using the same smart card reader can be transmitted to different TSPs.

Alternatively or additionally, the coordinator is configured to select the TSP to carry out a specific transaction randomly or based on attributes of the TSP, such as the cost of the transaction (e.g., selecting the TSP with the lowest cost). In some embodiments, the coordinator monitors the response times of the different TSPs and for at least some transactions the coordinator selects a TSP which is responsive and can handle the transaction.

Optionally, the coordinator is a standalone unit, which is separate from smart card readers and computers to which the smart card readers are directly connected on the one hand, and separate from a TSP, carrying out the transaction, on the other hand. The term separate is taken in the present application to refer to the coordinator being in a separate casing and possibly distanced from the smart card reader and the TSP, by at least 5 meters, 50 meters, 500 meters or even at least light year. In some embodiments of the invention, the coordinator is connected to the TSP, cardholder's computer, the smart card reader and recipient's computer through a protocol for long distance connections, such as an Internet Protocol (IP) network (e.g., the Internet).

Separating the coordinator from the TSP allows flexibility in operating with a plurality of different TSPs and thus offloads the load on the TSPs.

For a transaction it handles, the coordinator optionally coordinates the transfer of the transaction details to the smart card reader for presentation to the cardholder for approval. Optionally, the coordinator also coordinates the tasks of a terminal, such as the Level 2 tasks of the EMV protocol. This coordination includes, optionally, instructing the smart card reader to verify a Personal Identification Number (PIN) entered by a cardholder. In other embodiments, the terminal is located on a cardholder computer to which the smart card reader is directly connected or the terminal is included in the smart card reader.

In some embodiments of the invention, the smart card reader displays the transaction details to the cardholder before authorization of the transaction, so that regardless of the security level of other transaction parties the cardholder can make sure that the transaction being authorized is actually the intended transaction.

Optionally, the communications between the smart card reader and the coordinator are encrypted, in a manner preventing any change to the details, by units along the communication path, including a personal computer or mobile device through which the smart card reader connects to the Internet.

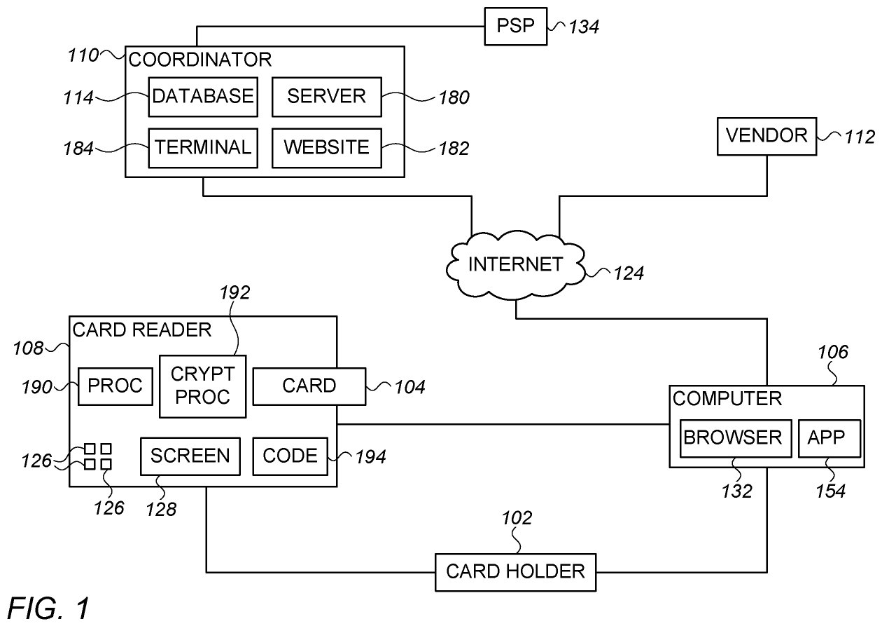

FIG. 1 is a block diagram of entities and units participating in a remote smart card transaction performed using a coordinator 110, in accordance with an embodiment of the invention.

A human cardholder 102, owning a smart card 104, performs a monetary transaction with a remote vendor 112. The remote vendor 112 is optionally a commercial website, contacted over the Internet 124, from a computer 106 of the cardholder 102, but may also be contacted using other methods, such as by telephone or personal communication. Computer 106 optionally executes a browser 132 which is used to access a website of vendor 112.

Cardholder 102 has a smart card reader 108, which serves as an electrical interface to smart card 104 and communicates with coordinator 110 through the Internet 124 and computer 106. Alternatively, smart card reader 108 connects to the Internet 124 through a different computer than computer 106, which is used by cardholder 102 to communicate with remote vendor 112, or through a built in modem within smart card reader 108. Smart card reader 108 interacts with smart card 104 by contact or wirelessly, for example using Near Field Communication (NFC) wireless connection. In some embodiments of the invention, the smart cards 104 include an encryptor, and the signals passing through smart card reader 108 are not decipherable by the smart card reader.

Smart card reader 108 may be a standalone unit, or may be included within computer 106. Smart card reader 108 is connected to computer 106 through a wire or wireless (e.g., contactless) connection. In one embodiment, smart card reader 108 is connected to computer 106 using a Universal Serial Bus (USB) connection.

A terminal (184) performs the various smart card access software tasks involved in reading smart card 104 by smart card reader 108. In some embodiments, terminal 184 is hosted by coordinator 110, thus reducing the complexity and cost of smart card reader 108. Alternatively, the terminal 184 is included within smart card reader 108. The tasks of terminal 184 optionally include the tasks of the EMV terminal.

Smart card reader 108 optionally includes a screen 128, for displaying transaction related details to cardholder 102. In addition, smart card reader 108 optionally comprises physical keys 126 for entering, for example, a Personal Identification Number (PIN). Alternatively, virtual keys on screen 128 may be used, or no keys at all, for example when a PIN is not required. In some embodiments, smart card reader 108 has the outside appearance and/or general structure of any of the smart card readers described in US patent publication 2015/0186866 to Lund, titled “System for Secure Payment over a Wireless Communication Network”, and/or in PCT publication WO 2014/106181, titled: “A method and an apparatus for securely signing application data”, the disclosures of which are incorporated herein by reference in their entirety. It is noted that the smart card reader 108 may have adaptations to implement features described herein, which are not described in any of the above documents.

Smart card reader 108 optionally includes a battery and/or has a wire or wireless power connection to computer 106 or to a dedicated power supply.

Smart card reader 108 optionally includes an internal secure cryptographic processor 192 which encrypts and/or decrypts transmissions and/or cryptograms exchanged with coordinator 110. Alternatively to a separate encryption/decryption processor, encryption and/or decryption are performed by a general processor 190 of smart card reader 108, by a secure access module mounted in smart card reader 108 or by a smart card104 using an additional application or applet on smart card 104. In some embodiments of the invention, smart card reader 108 includes a tamper-responsive secure memory 194, which stores a secret key of smart card reader 108, used, for example, to prove authenticity of the smart card reader.

Smart card reader 108 is optionally tamper-resistant, tamper-evident and/or tamper-responsive, in order to prevent reverse engineering and changing the smart card reader by unauthorized parties. It is noted, however, that the below described method of using smart card reader 108, which is owned and managed by the cardholder, reduces the opportunities available to third parties to tamper with smart card reader 108. In some embodiments of the invention, smart card reader 108 is enclosed in a housing formed at least partially by a transparent material. Use of a transparent housing for smart card reader 108 increases the ability to enforce tamper-responsiveness.

In some embodiments of the invention, smart card reader 108 is designed to erase from its internal memory all information related to a smart card 104 inserted therein, upon removal of the smart card 104 from the smart card reader 108. This erasure is a feature of hardware and firmware of the smart card reader which optionally cannot be changed without tampering. In some embodiments, this feature of the smart card reader is not affected by any application, such as BadUSB, voltage drops, electrostatic discharge, burnt chips or anything else.

Smart card reader 108 is optionally configured to operate with credit, debit and/or prepaid smart cards. The smart cards may be EMV, a restricted version of EMV or custom smart cards. Possibly, a physical smart card 104 hosts data of a plurality of virtual smart cards, selectable by the user.

In some embodiments of the invention, the smart card reader 108 includes fewer elements than described above with reference to FIG. 1. For example, in some embodiments, smart card reader 108 does not have a slot for receiving smart card 104, and instead has an antenna for wireless communications with smart cards. Possibly, smart card reader 108 does not include screen 128 and/or keys 126. Optionally, in such cases, smart card reader 108 is miniaturized and fits on a small electronic device, such as a card in the size and shape of an Secure Digital (SD) memory card or of a subscriber identification module (SIM) card. In some embodiments of the invention, the functions of smart card reader 108 are added to an SD memory card or a SIM card. Alternatively, smart card reader 108 may be implemented on a card smaller than an SD memory card or even smaller than a SIM card.

Computer 106 may include a desktop computer, a laptop computer, a mobile device such as a PDA (personal digital assistant), a cellphone or a smartphone, or any other suitable general purpose computing device.

The transaction details and information from the smart card are transferred by coordinator 110 to a transaction service provider (TSP) 134, which together with other parties carries out the transaction, for example by transferring funds from an account of cardholder 102 managed by an issuer, to an account of the vendor 112, managed by an acquirer. It is noted that instead of transferring funds through an acquirer, payment service provider 134 may optionally transfer the funds from the issuer of smart card 104 to an electronic purse of vendor 112. The electronic purse is optionally associated with an EMV card of the vendor 112 or to a credit card ID account of the vendor.

In some embodiments of the invention, coordinator 110 operates with one transaction service provider 134. In other embodiments, coordinator 110 operates with a plurality of transaction service providers 134.

Coordinator 110 optionally includes a server 180 to interact with client application 154, a website 182 to interact with browser 132 and a database 114 to store transaction information being processed.

Coordinator 110 processes transaction details obtained from vendor 112 and cardholder 102, in order to show transaction related information on smart card reader screen 128 and to obtain confirmation from the cardholder 102.

Coordinator 110 may contact TSP 134 directly over a dedicated connection or may be connected to TSP 134 through a general purpose connection, such as the Internet 124. While coordinator 110 may be located at any distance from TSPs 134, in some embodiments coordinator 110 is configured with a high speed connection to TSP 134, in order to achieve a fast response time. In some embodiments, the coordinator is physically located close to TSP 134, for example within less than 10 miles or even one mile from the PSP, so that transactions are performed with low processing delay. Possibly, coordinator 110 is located in a same room or building with TSP 134 and/or is connected to a same local area network as TSP 134.

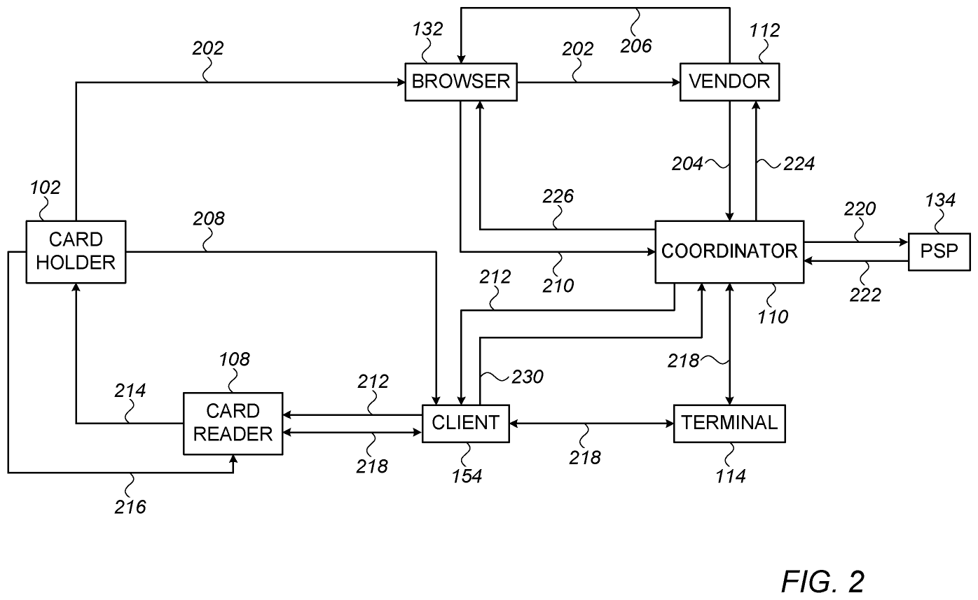

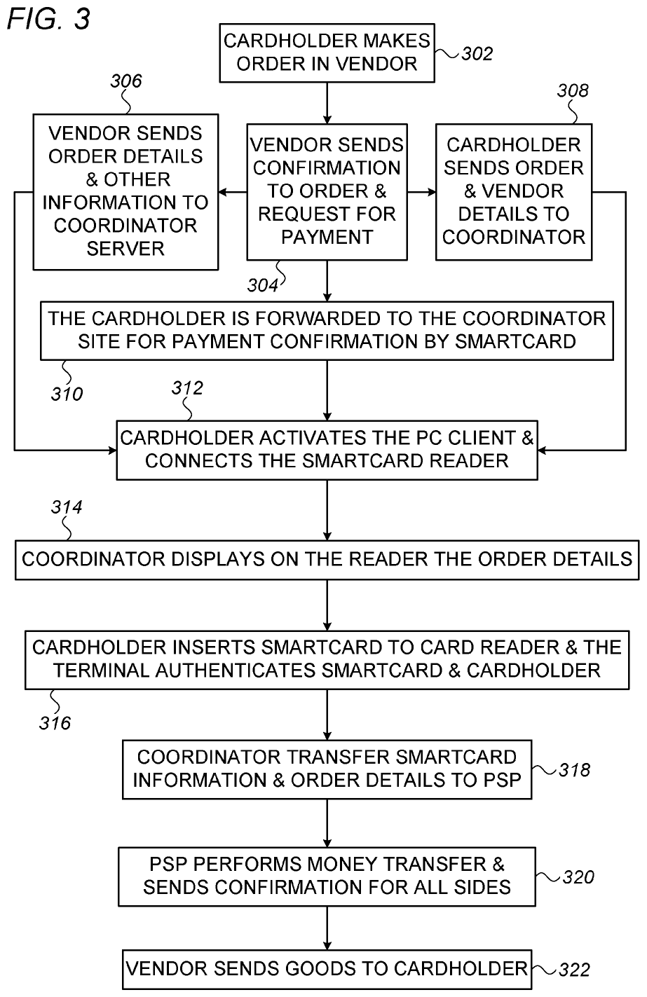

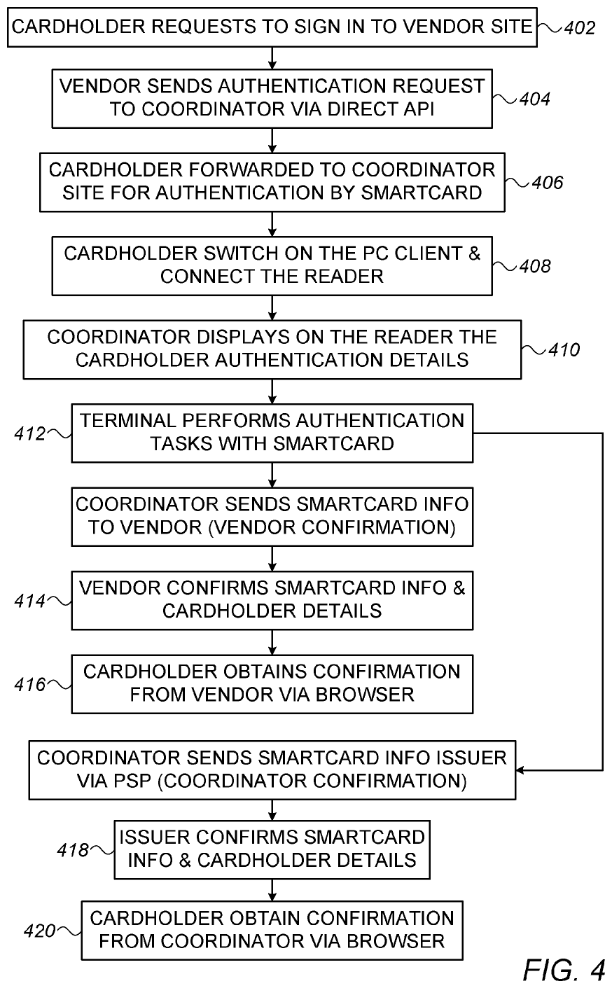

FIG. 2 is a schematic illustration of the communications involved in a payment transaction, in accordance with an exemplary embodiment.

In the first stage (202), cardholder 102 contacts vendor 112, for example, using browser 132, selects one or more items or services and indicates a desire to pay for the selected items or services using a smart card 104. For example, cardholder 102 indicates a desire to pay using smart card 104, by clicking a banner on the vendor's website. When the cardholder clicks on the banner, vendor 112 redirects browser 132 to website 182. Website 182 asks cardholder 102 to invoke (208) client application 154 which establishes secure connection (230) with coordinator 110. Following the cardholder's indication, vendor 112 sends (204) transaction details to coordinator 110 and/or to the browser 132 (206). The transaction details include an IP address of browser 132, used by coordinator 110 to bind the instance of client application 154 with the transaction.

Following the instruction of application 154 or browser 132, in order to confirm the transaction, cardholder 102 connects smart card reader 108 to computer 106, inserts smart card 104 into smart card reader 108 and actuates (216) the transaction by clicking a button on card reader 108 or application 154 or browser 132. Browser 132 may transfer cardholder's instructions to application 154 via local ports. In what follows we consider embodiments where cardholder 102 interacts with application 154, but cardholder 102 can also interact with browser 132 which interacts with application 154 via local ports.

Then coordinator 110 sends (212) transaction details to smart card reader 108 through client application 154 on computer 106. The transaction details are optionally provided to smart card reader 108 using cryptographic methods which prevent changing the details along the path between coordinator 110 and smart card reader 108. Smart card reader 108 displays (214) some or all of the transaction details on its screen 128 in accordance with cardholder's requests in application 154 or smart card reader keyboard 126.

Smart card reader 108 and coordinator 110 then conduct a predefined transaction process (218) in which information is exchanged between smart card 104 and coordinator 110 for authorization. In some embodiments, the predefined transaction process is in accordance with the EMV specifications, as described in the EMV books from EMVCo, although other processes may be used as well, such as future protocols replacing the EMV protocol.

Coordinator 110 transfers (220) required details of the transaction including a part of data obtained during the predefined transaction process (218), to a payment service provider (PSP) 134, which performs the payment transaction and returns (222) confirmation to coordinator 110. Coordinator 110 then optionally sends confirmation (224) to vendor 112 and/or (226) to browser 132 and/or client application 154.

In the first stage (202), browser 132 provides an address (e.g., IP address) and optionally other identification of computer 106 and/or browser 132 to be provided by vendor 112 to coordinator 110. When browser 132 or client application 154 contacts (230) coordinator 110, the provided address and/or other identification is optionally used by coordinator 110 to correlate browser 132 or client application 154 with the transaction details previously provided (204) by vendor 112.

Referring in more detail to vendor 112 sending (204) transaction details to coordinator 110, in some embodiments the transaction details include details of the service or product being purchased, date, the price and payment conditions (e.g., the number of installments) and the address (e.g., IP address) and/or other identification of computer 106 and/or browser 132.

In some embodiments, in parallel to sending (204) transaction details to coordinator 110, vendor 112 sends (206) transaction details and/or redirection instructions to browser 132, from a server 112 of the vendor. Optionally, the vendor 112 instructs cardholder 102 to connect smart card reader 108 to computer 106 and to initiate a client application 154, which controls the communications with smart card reader 108. Alternatively, the client application 154 may run continuously on computer 106 in a background mode which monitors a local port to intercept messages transmitted to computer 106 from website 182 of coordinator 110. When vendor 112 sends computer 106 an instruction to connect to coordinator 110, the client application 154 identifies the instruction and moves into a full operation mode in which it opens a window for interaction with cardholder 102. Furthermore, in some embodiments, when client application 154 identifies the instruction from vendor 112 it automatically extracts transaction details transmitted from vendor 112 for presentation to cardholder 102.

While the aforementioned vendor 112 is described as providing coordinator 110 a first notification (204) of the desired transaction, in other embodiments the first notification may be provided from computer 106 of the cardholder 102. For example, when cardholder 102 indicates to vendor 112 through browser 132 a desire to conduct a transaction, vendor 112 optionally sends its contact details to browser 132, possibly with an identification of a specific transaction, for contacting vendor 112 by coordinator 110. Browser 132 contacts (210) coordinator 110 and provides the contact details of vendor 112.

Referring in more detail to contacting (210) coordinator 110 by browser 132, in some embodiments, a website of vendor 112 includes an icon or banner with a hyperlink to coordinator 110. To initiate contact with coordinator 110, cardholder 102 optionally clicks on this icon or banner. Alternatively or additionally, cardholder 102 contacts (210) coordinator 110 from a web browser tab or window, separate from that used for contacting vendor 112.

Optionally, before sending (212) transaction details to smart card reader 108, coordinator 110 sends the details of the transaction, such as a list of the products being purchased and the price being paid, to browser 132. The transaction details may further include the terms of payment and/or a shipping choice. The details are optionally accompanied by one or more controls, which may be used by cardholder 102 to instruct coordinator 110 to send (212) the transaction details to smart card reader 108. Before sending (212) transaction details to smart card reader 108, coordinator 110 optionally sends the details of the transaction to client application 154. Alternatively or additionally, the details are accompanied by one or more controls of client 154, which may be used by cardholder 102 to instruct client 154 to send (212) the transaction details to the smart card reader 108. Alternatively or additionally, the details are accompanied by an explanation on how the cardholder 102 can invoke the sending of the details to smart card reader 108.

In contacting (210) coordinator 110 by browser 132, the browser optionally provides an address and/or a unique ID number of smart card reader 108. Optionally, coordinator 110 manages a database of smart card reader addresses corresponding to respective browser or user IDs or smart card reader IDs corresponding to secret keys.

In order to allow for sending (212) transaction details to smart card reader 108, cardholder 102 optionally actuates a client application 154, such as an applet, plug-in or other dedicated program on computer 106, which establishes a connection between coordinator 110 and smart card reader 108. In some embodiments, the client application 154 is downloaded from coordinator 110 if not already available on computer 106. Optionally, the communication between smart card reader 108 and coordinator 110 is mediated in accordance with a Personal Computer/Smart Card (PC/SC) protocol, by client application 154.

Client application 154 contacts smart card reader 108 and optionally receives from it an identification number of the smart card reader 108 and optionally a session counter. This information is sent by client application 154 to coordinator 110 which returns the details of the transaction encrypted or signed by a cryptogram for delivery to smart card reader 108, which after decryption and/or authentication displays them on screen 128.

Optionally, coordinator 110 identifies client 154 or smart card reader 108, as being associated with browser 132, based on their use of the same IP address.

Alternatively or additionally, any other method may be used to match browser 132 with client 154 or smart card reader 108, for example assignment of a unique transaction ID. In some embodiments, coordinator 110 continuously synchronizes the transaction details provided to browser 132 and to client 154.

As to the display (214) of the transaction details on the screen of the smart card reader 108, in some embodiments the details are all displayed statically on the screen.

Alternatively, smart card reader 108 displays details of a plurality of possible transactions and the user may scroll between the possible transactions and select the desired transaction.

In some embodiments, before inserting smart card 104 into smart card reader 108, cardholder 102 can initiate a smart card reader verification procedure, which verifies that the smart card reader 108 is an expected authentic smart card reader without backdoors or other hardware and/or firmware designed to steel the cardholder's smart card details. The verification procedure is optionally actuated on a trusted computer, for example, computer 106 if it is considered trusted. The smart card reader verification procedure may be a part of client application 154 or may be a separate software program. The smart card reader verification procedure is able to sniff and disable computer ports to which smart card reader 108 should connect, for example, USB ports, in order to prevent installation of malicious smart card readers and maintain trustworthiness of the computer.

In some embodiments, the smart card reader verification is based on a common encryption key embedded in all smart card readers 108 of a specific smart card reader vendor. The smart card reader verification procedure optionally performs:

a) establishing a secure connection with coordinator 110;

b) receiving an unpredictable random challenge from coordinator 110;

c) transferring the unpredictable random challenge to smart card reader 108;

d) smart card reader 108 encrypts the challenge in a predetermined manner using the encryption key and transfers the encrypted result to the smart card reader verification procedure;

e) the smart card reader verification procedure transfers the encrypted result to coordinator 110, which determines whether the challenge was met;

f) a response as to whether the challenge was met is received from coordinator 110 and displayed to cardholder 102 on a screen of trusted computer 106.

In some embodiments, smart card reader 108 has an asymmetric public-private key pair which is used for authentication. In these embodiments, the authentication can be performed by coordinator 110 or by the smart card reader verification procedure running on trusted computer 106, on its own, without aid of coordinator 110.

In still other embodiments, each smart card reader is assigned a secret key which matches its identification number. Coordinator 110 stores a database of identification numbers and corresponding secret keys and checks whether test results from the smart card reader verification procedure match the database.

In one embodiment, smart card reader 108 uses a secret session key, for authentication, and provides the smart card reader ID and a session counter with the encrypted challenge. Coordinator 110 uses the smart card reader ID and the session counter to derive the secret session key that should have been used in authentication and accordingly determines the authenticity of smart card reader 108.

Instead of receiving the unpredictable challenge from coordinator 110, the challenge may be generated by the smart card reader verification procedure and sent with the smart card reader response to coordinator 110.

Alternatively to using software generated (e.g., pseudo-random) challenges, cardholder 102 may enter the challenge into the smart card reader verification procedure. In this case, the smart card reader verification procedure displays the smart card reader's challenge and response to cardholder 102, optionally with a smart card reader ID and/or a session counter. The smart card reader's response may be displayed on screen 128, for example, as text, an image or a one-dimensional or two-dimensional barcode. In some embodiments, cardholder 102 may scan the response, for example using a smartphone application and transmit the response to coordinator 110 or a different trusted server which decrypts the response and responds to the smartphone. Such out-of-band transfer of the challenge response to coordinator 110 or different trusted server avoids a possibility of a fake smart card reader 108 designed to contact a false verification server or forge contact with a verification server and makes trustworthiness of the computer unnecessary. It is noted that in these embodiments, coordinator 110 decrypts the response and returns the decrypted response to the smartphone of cardholder 102 for display to cardholder 102 and verification by the cardholder. The challenge response is optionally encrypted using symmetric or asymmetric cryptography.

A technical paper of Vasco, titled Digipass 920, available from https://www.vasco.com/Images/DP_920_DS201010_v3.pdf describes a technology for smart card reader verification: “Reader signature. The bank which issues DIGIPASS 920 to its customers can verify that a transaction is approved and signed by his customer with a genuine smart card reader. When that same transaction is signed by an unauthorized smart card reader it would have been rejected. As a result, DIGIPASS 920 offers additional security guarantees on both sides of the transaction. The end-user can trust the data he digitally signed since they were displayed in the secure environment of a trusted smart card reader. The bank who issued the smart card reader can check that his genuine “WYSIWYS” smart card reader has been used during the transaction. This verification can also be undertaken by any third party linked to the bank who issues the smart card reader without compromising the smart card reader security or having to share any secure key stored into the smart card reader.” However, the above procedure does not guarantee the authenticity of the smart card reader before the card is used for the first time, as compared to the methods proposed here.

Optionally, if the smart card reader 108 is connected to computer 106 with a smart card 104 already inserted in the smart card reader 108 or a voltage drop occurs, smart card reader 108 requires removal of the smart card 104 and reinsertion of the smart card 104, before any action will be taken. This feature is configured in the hardware and firmware of smart card reader 108 so that it cannot be changed without tampering. Optionally, smart card reader 108 registers internally the first transaction ID number received after a smart card 104 was inserted and does not allow a smart card operate on a different transaction unless the smart card 104 is reinserted. This feature can be viewed as an imprinting of smart card reader 108 with the transaction details, so that a smart card insertion thought by a user to pertain to a specific transaction cannot be changed to a different transaction without reinsertion of the smart card 104 by the cardholder 102. Optionally, “Clear” button on keyboard 126 of smart card reader 108 or transaction completeness can be used for the transition to the new transaction instead card reinsertion.

Optionally, the transaction details are sent (212) to smart card reader 108 in the form of an Extensible Markup Language (XML) element, including name-value pairs of attributes. The list of attributes can be provided by a vendor and can vary from vendor to vendor. The details of the transaction optionally include an identification number, assigned by coordinator 110, an indication of the vendor identity, and details of the vendor, such as a mailing address of the vendor, a mailing address of the customer, a date of the transaction and/or the transaction amount. In some embodiments, the details also include a number of installments and possibly the amount of each installment. Alternatively or additionally, the details include the currency of the transaction. Optionally, the use of imprinting options can be adjusted using attributes, particularly, transaction ID. One of the attributes can be the cardholders IP or cardholders approximate location derived from the cardholders IP from the point of view of coordinator 110. Including such attribute can be used to prevent overseas man-in-the-middle attacks on confidential information in the case of using the system for authentication on compromised computer 106.

Optionally, the details are sent (212) to smart card reader 108 in a form including for each attribute a name of the attribute and the corresponding value of the attribute. A name-value pair which corresponds to any one of the transaction details sent (212) to smart card reader 108 are optionally encrypted and/or confirmed by a cryptogram, for example by a Message authentication code (MAC). The cryptogram optionally confirms the name-value pair together with the coordinator assigned transaction ID. The cryptogram is optionally applied only to a sub-portion of the exchanged details, for example to the identification number of the transaction and/or to the vendor identity and sum of the transaction. Optionally, the cryptogram is applied to all the exchanged information. Encryption is optionally applied to all the exchanged details.

Optionally, client application 154 includes an interface which has a set of buttons or other input means. In some embodiments, at least some of the buttons correspond to the attributes of transactions. In some cases, screen 128 of smart card reader 128 is not sufficiently large to allow display of all the details at once on the screen. Optionally, cardholder 102 can use the buttons of client application 154 to indicate a specific attribute of the transaction, the name and the value of which are to be displayed on screen 128. Before displaying the attribute name and value, smart card reader 108 optionally verifies that the cryptogram protecting the attribute is valid. In some embodiments, when the initial set of cryptograms sent for the transaction protects only some of the transaction details, not including the detail currently requested by cardholder 102, client application 154 requests coordinator 110 to resend the detail with a supplementary cryptogram. Smart card reader 108 verifies that the supplementary cryptogram is valid and has the same transaction ID as the original cryptogram and displays the name-value pair. Otherwise the smart card reader displays an error message and resets until the smart card is reinserted or “Clear” button on smart card reader 108 is pressed.

Optionally, coordinator 110 supplies an attribute with the transaction details, possibly an unpredictable number, which can be used by cardholder 102 to view the transaction details using a connection to coordinator 110 separate from the connection through smart card reader 108 and/or computer 106. As stated previously, cardholder 102 can view the name and value of the attribute on smart card reader screen 128 by pressing the corresponding button on application 154. Then cardholder 102 may enter the attribute value of the transaction into a website and/or application of coordinator 110, in a smartphone, and view thereon the details of the transaction. This allows the cardholder to view the details of the transaction being authorized in full text without depending on computer 106. Optionally, when computer 106 is not considered trusted the transmission of the attribute between smart card reader 108 and coordinator 110 is encrypted.

The verification of the transaction details by cardholder 102 may be performed before the transaction process (218) and/or in parallel to first stages of the transaction process (218) performed before PIN entering, namely, Application Selection, Read Application Data, and Offline Data Authentication.

In some embodiments, actuating (216) the transaction is performed by pressing a button on the smart card reader 108 and/or entering a PIN to smart card reader 108. In some embodiments of the invention, actuating (216) the transaction includes entering a biometric identification, such as a finger print, face, eye, voice, signature and/or typing identification.

The transaction process (218) is optionally performed in a secure manner, using any suitable method known in the art, for example the method described in U.S. Pat. No. 5,336,870 to Hughes et al., titled: “System for Remote Purchase Payment Transactions and Remote Bill Payments”, the disclosure of which is incorporated herein by reference in its entirety.

As stated above, in some embodiments, actuating (216) the transaction includes entering a PIN using a keyboard of smart card reader 108.

Alternatively to entering the PIN to smart card reader 108, the PIN is entered to a textbox in client application 154 on computer 106. Optionally, in order to prevent theft of the PIN by spy software on computer 106, coordinator 110 transmits an encrypted multi-digit (e.g., ten-digit) number N to smart card reader 108. Smart card reader screen 128 displays N to cardholder 102 and cardholder 102 uses this number as a TURing image, for example, according to the description in a white paper of Swivel Secure titled, TURing, from 2003, available at http://www.krome.co.uk/wp-content/uploads/Swivel-TURing-Data-Sheet.pdf. In some embodiments, when the cardholder 102 brings focus to the textbox in the application, the smart card reader 108 displays the ten-digit number N on its screen 128. In the case of an Offline PIN, application 154 sends the user entered number to smart card reader 108 which recovers the PIN and sends the PIN to card 104. In the case of an Online PIN, application 154 sends the entered number to coordinator 110 which recovers the PIN and sends the PIN to the TSP. An unpredictable number for TURing image can be taken also from the card. For Online PIN verification the unpredictable number is encrypted by smart card reader 108 and sent to coordinator 110, instead of receiving the unpredictable number from the coordinator.

For Offline Enciphered PIN verification, smart card reader 108 optionally supports asymmetric cryptography and, for example, has a tamper-evident secure PIN pad.

In some embodiments of the invention, decimal addition without carry is used in PIN entering instead of using this number as TURing image. Cardholder 102 adds the first digit of the PIN with the first digit of N modulo 10, and writes the result into the textbox. The same is done with other digits of the PIN, analogically to exclusive or (XOR) cipher. Cardholder 102 clicks on a button and the application sends the contents of the textbox to the smart card reader 108. The smart card reader 108 calculates the PIN and sends it to the card. A script on a website of coordinator 110 is optionally supplied to allow cardholders to rehearse this procedure. In this case no information about the PIN is revealed.

In some embodiments, coordinator 110 is associated with a single TSP 134 and the transfer (220) of transaction data is performed to this TSP 134. In other embodiments, coordinator 110 is associated with a plurality of TSPs 134. In those embodiments, coordinator 110 optionally selects a TSP to carry out the transaction. In some embodiments, the TSP is selected randomly from the TSPs 134 currently operative. Alternatively or additionally, coordinator 110 calculates the charge to be required by each TSP 134 for carrying out the transaction and accordingly selects a cheapest TSP 134 for the specific transaction. For example, if one of the TSPs charges a fixed sum for each transaction and another TSP charges a percentage of the transaction amount, coordinator 110 optionally calculates the sum charge by each TSP based on the current transaction amount and accordingly selects the TSP from which to request carrying out the transaction. For this purpose, coordinator 110 optionally monitors the charge schedule of each TSP 134. Alternatively, during the monetary transaction of FIG. 2, coordinator 110 queries a plurality of TSPs 134 as to the charge for the transaction and accordingly selects a TSP 134 to carry out the transaction.

In some embodiments, coordinator 110 monitors the response times of TSPs 134 and accordingly selects a TSP 134 to carry out the current transaction. The selection may be based solely on the response time or based on both response time and cost and possibly other considerations.

FIG. 3 is a flowchart of acts performed during a money transfer transaction, in accordance with an embodiment of the invention. The method begins with a cardholder 102 making (302) an order from a vendor 112. In response, the vendor sends (304) a confirmation and a request for payment to the cardholder. The vendor also sends (306) order details to coordinator 110 through its application programming interface (API).

Cardholder 102 is redirected (310) to a website of coordinator 110 for payment with a smart card. Cardholder 102 sends (308) the vendor details to coordinator 110. Upon a prompt from the website, or possibly on his/her own initiative, the cardholder 102 connects the smart card reader 108 to the computer 106 and activates (312) client application 154. Coordinator 110 then transmits the details of the transaction to smart card reader 108, where the details are displayed (314) for authorization by cardholder 102. Cardholder 102 inserts the smart card 104 into the smart card reader 108 and the terminal 184 authenticates (316) the smart card and cardholder, for example in accordance with the EMV standard. Following successful authentication, coordinator 110 transfers (318) smart card information and the transaction details to PSP 134, which generates (320) instructions for the transfer of money in accordance with the transaction details and issues confirmation of the transaction. Thereafter, the vendor 112 supplies the goods or services paid for in the transaction to the cardholder 102.

It is noted that the order of the acts shown in FIG. 3 is not the only order that can be used in accordance with embodiments of the present invention. For example, in some embodiments, the act of authenticating (316) the cardholder and smart card may be split into two or more separate acts performed at different stages of the method of FIG. 3. For example, in one embodiment, the authentication of the smart card is performed before displaying (314) the order details, while the authentication of the cardholder is performed in this embodiment after display of the order details.

FIG. 4 is a flowchart of acts performed during an authentication transaction, in accordance with an embodiment of the invention. In the transaction of FIG. 4, the cardholder 102 is used to verify login into the vendor's website, for example in order to give a payment instruction to the website. In accordance with embodiments of the present invention, the authentication is performed by coordinator 110 rather than by the vendor 112. When a user requests (402) to login to the vendor website, the vendor optionally sends (404) an authentication request to coordinator 110, for example via a direct application program interface (API). The vendor site forwards (406) the cardholder 102 to a website of coordinator 110, for authentication of the smart card. The cardholder 102 connects the smart card reader 108 to the computer 106 and activates (408) client application 154. Coordinator 110 displays (410) the authentication details on the smart card reader 108. The terminal 184 performs (412) the authentication tasks with the smart card 104 and then coordinator 110 sends the smart card information to an entity designated to authenticate the information.

In some embodiments of the invention, the authentication is performed by the vendor (414) and the vendor optionally provides (416) cardholder 102 with access confirmation through the browser. In other embodiments, the authentication is performed (418) by an information issuer contacted through TSP 134. Confirmation of authentication is optionally provided (420) to the cardholders browser from coordinator 110.

As stated above regarding the method of FIG. 3, also regarding the method of FIG. 4 the order of some acts may be changed still in accordance with the present invention. For example, the authentication may be split into several separate acts, such as separately authenticating the smart card and cardholder, with the display of some or all of the transaction details being performed between the separate authentication acts.

It is noted that the smart card confirmation may be used several times during a communication session with a website. For example, a first smart card authentication may be carried out when logging in to the website and further smart card confirmations may be performed when attempting to give instructions and/or accessing confidential data. For example, when the vendor managing the website is a bank, the smart card may be used to access personal information on the website of the bank and for each instruction initiated.

The above described authentication method may be used for various applications, such as card present transactions, e-commerce, online payments, online banking, blockchain/Bitcoin, Internet of things, digital ID, smart cities, connected cars and/or cloud/big data.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Apparatus for managing smart card transactions, comprising:
one or more communication interfaces for connecting to processors of vendors, customers and payment server processors; and
a processor configured to receive details of a transaction from a vendor processor, to transmit the transaction details to a smart card reader identified by the received details, to receive from a smart card within the smart card reader a cryptogram authorizing the transaction, to transfer the details of the transaction and the cryptogram to a payment server processor (PSP) to carry out the transaction, to receive confirmation of the transaction from the PSP through the interface and to transmit confirmation of the transaction to both the vendor processor and a customer processor.

2. The apparatus of claim 1, wherein the processor is configured to perform smart card reader terminal tasks.

3. The apparatus of claim 1, wherein the processor is configured to encrypt the confirmation transmitted to the vendor processor and the customer processor.

4. The apparatus of claim 1, wherein the processor is configured to transmit the transaction details to the smart card reader along with an initial cryptogram over a sub-group of the details of the transaction and to send a supplementary cryptogram to the smart card reader for additional details of the transaction, in response to a request from a user.

5. The apparatus of claim 1, wherein the processor is configured to transmit the transaction details to the over a communication channel separate from the channel used in providing the details to the processor from the vendor processor.

6. The apparatus of claim 1, wherein the processor does not store secret information required for verification of smart cards.

7. The apparatus of claim 1, wherein the processor is configured to select a PSP from a plurality of PSPs to which to transfer the details of the transaction and the cryptogram, for each transaction.

8. The apparatus of claim 7, wherein the processor is configured to select the PSP responsive to an estimated charge of each of the plurality of PSPs for carrying out the transaction.

9. The apparatus of claim 7, wherein the processor is configured to select the PSP responsive to an estimated current response time of each of the plurality of PSPs.

10. A smart card reader, comprising:
a communication interface;
a smart card interface;
a screen; and
a processor configured to receive transaction details through the communication interface, to display the details on the screen, and to manage authentication of a smart card contacted though the smart card interface with a smart card software terminal contacted through the communication interface,
wherein the processor is configured to refuse operation until a smart card is removed from the smart card interface and the connection with the smart card is reestablished, if the smart card reader is switched on while a smart card is in contact with the smart card interface.

11. The smart card reader of claim 10, comprising a memory storing an authentication code of the smart card reader.

12. The smart card reader of claim 10, comprising a memory storing a unique secret smart card reader key to encrypt and decrypt sensitive smart card information and commands communicated from the smart card reader.

13. The smart card reader of claim 10, wherein the processor is configured to authorize only transactions whose details were first received after a smart card was brought in contact to the smart card interface and to refuse to operate with different transaction details provided subsequently unless the smart card is again brought in contact with the smart card interface.

14. A method for managing smart card transactions, comprising:
receiving by a processor of a transaction coordinator, details of a transaction from a vendor processor;
transmitting the transaction details from the processor of the transaction coordinator to a smart card reader connected to a client computer;
receiving from a smart card within the smart card reader a cryptogram authorizing the transaction;
transferring the details of the transaction and the cryptogram to a payment server processor (PSP) to carry out the transaction; and
receiving confirmation of the transaction from the PSP.

15. The method of claim 14, and comprising transmitting confirmation of the transaction to both the vendor processor and the client computer, responsive to receiving the confirmation from the PSP.

16. The method of claim 14, wherein transmitting the transaction details from the processor of the transaction coordinator comprises transmitting the transaction details to the smart card reader along with an initial cryptogram over a sub-group of the details of the transaction and sending a supplementary cryptogram to the smart card reader for additional details of the transaction, in response to a request from a user.

17. The method of claim 14, comprising selecting a PSP from a plurality of PSPs to which to transfer the details of the transaction and the cryptogram, for each transaction.

18. The method of claim 17, wherein selecting the PSP comprises selecting responsive to an estimated charge of each of the plurality of PSPs for carrying out the transaction.

19. The method of claim 17, wherein selecting the PSP comprises selecting responsive to an estimated current response time of each of the plurality of PSPs.
